(19) United States
(12) Patent Application Publication
(10) Pub. No.: US 2025/0309743 A1
(43) Pub. Date: Oct. 2, 2025

(54) SECONDARY PART OF AN IRONLESS LINEAR MOTOR AND IRONLESS LINEAR MOTOR

(71) Applicant: ETEL S.A., Môtiers (CH)

(72) Inventors: Michele GAFFURI, Couvet (CH); Pierre Alexandre BISCHOFF, Mont la ville (CH); Philippe TAMIGNIAUX, Morteau (FR)

(21) Appl. No.: 19/088,348

(22) Filed: Mar. 24, 2025

(30) Foreign Application Priority Data
Mar. 26, 2024 (EP) 24166509.0

(51) Int. Cl. H02K 41/03

(52) U.S. Cl. CPC H02K 41/031

(57) ABSTRACT

A secondary part for an ironless linear motor includes two yoke plates having an inner side and an outer side, a first and a second set of permanent magnets fixed on the inner side of the respective yoke plate, a spacer member mounted between the two yoke plates, and a reinforcement structure. The reinforcement structure includes a reinforcement part arranged on the outer side of the yoke plates and a fixation part fixed on opposite sides of the spacer member such that the first and second sets of permanent magnets face each other to define a magnetic path for a primary part of the linear motor. The fixation part of the reinforcement structure covers less than 80% of the surface of the opposite sides of the spacer member. An ironless linear motor includes such a secondary part.

### CROSS-REFERENCE TO RELATED APPLICATIONS

The present application claims priority to application Ser. No. 24/166,509.0, filed in the European Patent Office on Mar. 26, 2024, which is expressly incorporated herein in its entirety by reference thereto.

### FIELD OF THE INVENTION

The present invention relates to a secondary part of an ironless linear motor, e.g., a low-weight secondary part of an ironless linear motor, and to an ironless linear motor, e.g., which includes such a secondary part. The ironless linear motor is, for example, suitable for use in connection with a motion system that includes XY motorized stages, e.g., in semiconductor processing equipment.

### BACKGROUND INFORMATION

Linear motors are used, for example, when there is a need for highly accurate and, in some instances, also rapid positioning of objects, such as a machine part of a machine tool. The primary part of the linear motor can thereby be directly connected via a suitable interface to the machine part to be moved.

What are generally referred to as ironless linear motors are primarily suited for applications that require an especially precise positioning where at least one coil provided on the primary part does not have an associated core, such as an iron core to reduce the weight. Disturbing cogging thrusts can thereby be avoided. However, to be able to generate high enough forces on the primary part of the linear motor, even without a core, correspondingly higher coil currents are required. The coils are generally provided in the form of preformed individual coils and are installed to produce the electric motor.

The secondary part of the linear motor should also be weight optimized. This is particularly the case when the secondary part, together with the primary part, e.g., the entire motor, is coupled to the primary part of another motor to provide an X-Y drive.

At the same time, the secondary part must meet stability requirements. The yoke plates of the secondary part, which are equipped with permanent magnets and form the magnetic path for the primary part, are subject to constant forces due to the magnetic field of the permanent magnets. This can lead to bending and thus deformation of the magnetic path. Excessive bending or deformation of the secondary part could lead to the primary part contacting the secondary part and thereby to damage of the permanent magnets. This could be avoided by enlarging the air gap, which leads to greater tolerance to deformation. However, this would be accompanied by performance losses. It is therefore preferable to reinforce the secondary part.

In this context, European Patent Document No. 3 471 245 describes a secondary part defining a magnetic path for a primary part of a linear motor. The secondary part includes a spacer and two yoke plates connected to the spacer such that the yoke plates are arranged opposite one another and extend perpendicularly to the magnetic path. An external side of each yoke plate includes a reinforcing structure with periodic variation in the thickness of the plate in the direction of the magnetic path.

U.S. Pat. No. 6,803,682 describes a secondary part including two yoke plates each having a greater cross-sectional dimension at locations between adjacent pairs of the magnets than at locations generally aligned with centers of the respective magnets. The force output to moving mass ratio of a motor incorporating such secondary part is improved over conventional configurations of magnet assemblies.

### SUMMARY

Example embodiments of the present invention provide a secondary part of a linear motor having a reinforcement structure.

Example embodiments of the present invention provide an ironless linear motor that includes such a secondary part or a secondary part assembly that includes several secondary parts assembled adjacently together.

According to example, embodiments, a secondary part for an ironless linear motor includes two yoke plates having an inner side and an outer side, a first and a second set of permanent magnets fixed on the inner side of respective yoke plates, a spacer member mounted between the two yoke plates, and a reinforcement structure. The reinforcement structure includes a reinforcing part arranged on the outer side of respective yoke plates and a fixation part fixed on respective opposite sides of the spacer member such that the first and second set of permanent magnets are facing each other to define a magnetic path for a primary part of the linear motor.

The fixation part of the reinforcement structure covers less than 80% of the surface of respective opposite sides of the spacer member.

According to example embodiments, the fixation part of the reinforcement structure covers less than 60%, e.g., less than 50%, of the surface of respective opposite sides of the spacer member.

According to example embodiments, the reinforcement part of the reinforcement structure includes reinforcement beams spaced apart from each other and extending from a top side to a bottom side of the outer side of respective yoke plates.

According to example embodiments, each reinforcement beam has a rectangular shape and is centered at the interface between two adjacent permanent magnets.

According to example embodiments, the fixation part of the reinforcement structure includes legs fixed to respective opposite sides of the spacer member and spaced apart from each other to form periodic cut-out portions therebetween.

According to example embodiments, each leg includes a fastening bore aligned with a centered reinforcement beam. Each leg further includes two inclined beams forming an integral part with two additional reinforcement beams arranged on both sides of the centered reinforcement beam.

According to example embodiments, each cut-out portion has a substantially triangular shape.

According to example embodiments, the spacer member includes a plurality of assembly holes between each pair of legs for fixing the secondary part to a machine part.

According to example embodiments, the reinforcement part of the reinforcement structure forms an integral part with respective yoke plates.

According to example embodiments, the reinforcement structure has a uniform thickness.

According to example embodiments, the spacer member is formed of aluminum or an aluminum alloy.

According to example embodiments, a secondary part assembly includes several secondary parts. The spacer member and respective yoke plates of each secondary part are located adjacently in the longitudinal direction of the magnetic path with the spacer member and respective yoke plates of an adjacent secondary part.

According to example embodiments, the assembly includes a casing having a rectangular recess receiving the secondary parts. The recess includes fixation parts against which the spacer member of each secondary part is fixedly mounted.

According to example embodiments, the casing further includes a longitudinal slot aligned with the magnetic path of each secondary part.

According to example embodiments, an ironless linear motor includes the secondary part or the secondary part assembly and a primary part movably mounted within the magnetic path of the secondary part or the secondary part assembly.

Further features and aspects of example embodiments of the present invention are described in more detail below with reference to the appended schematic Figures.

### BRIEF DESCRIPTION OF THE DRAWINGS

FIG. 1 is a perspective view of a secondary part of an ironless motor with a reinforcement structure.

FIG. 2 is a top view of the secondary part illustrated in FIG. 1.

FIG. 3 is a side view of the secondary part illustrated in FIG. 1.

FIG. 4 is a perspective view of a secondary part assembly with an open side showing two secondary parts and one being assembled.

### DETAILED DESCRIPTION

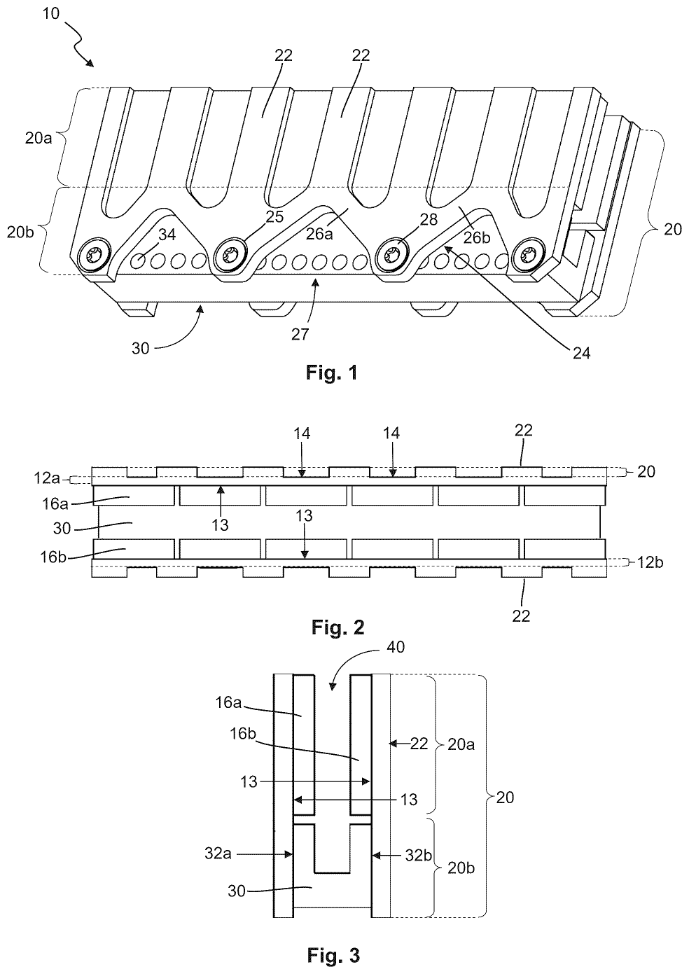

FIGS. 1 to 4 illustrate a secondary part 10 that define a magnetic path 40 for a primary part of an ironless linear motor that includes a series of coils arranged to be energized by an alternative current. The secondary part 10 includes a spacer member 30 and two yoke plates 12a, 12b that form lateral sides of the secondary part and that extend in mutual opposition and orthogonally to the magnetic path 40. These two yoke plates are fastened to the spacer member 30 via a reinforcement structure 20 arranged on an outer side 14 of respective yoke plates 12a, 12b, as described in more detail below.

A first set of permanent magnets 16a are fixed next to each other on an inner side 13 of first yoke plate 12a, and a second set of permanent magnets 16b are fixed next to each other on an inner side 13 of the second yoke plate 12b to define the magnetic path 40 for the primary part of the linear motor. The first and second sets of permanent magnets 16a, 16b are affixed, for example, by glue, and are disposed with alternating poles beside one another and with alternating poles opposite one another.

The two yoke plates 12a, 12b are made of a high magnetic permeability material, such as steel, to guide the magnetic field generated by the permanent magnets 16a, 16b to improve the performance of the linear motor.

The spacer member 30 is, for example, formed of a low-weight material, such as aluminum or an aluminum alloy, to limit as much as possible the weight of the secondary part. The low relative magnetic permeability of aluminum or an aluminum alloy does not impact the performance of the linear motor as the space member 30 is located outside the magnetic field created within the magnetic path 40. The spacer member 30 has a U-shaped cross-section to form a groove along the magnetic path.

The reinforcement structure 20 for both yoke plates 12a, 12b withstands constant forces due to the magnetic field of the permanent magnets, thereby avoiding bending of the yoke plates and thus deformation of the magnetic path 40. The reinforcement structure 20 includes a reinforcement part 20a, which may form an integral part with respective yoke plates 12a, 12b, and a fixation part 20b fixed to the spacer member 30. The reinforcement part 20a of the reinforcement structure 20 may have a uniform thickness, as illustrated. The reinforcement part may be tapered by a milling operation or similarly structurally formed and locally narrowed in terms of the thickness thereof.

The reinforcement structure may be fixed as a separate component on the outer side of respective yoke plates, for example, adhesively bonded or otherwise fastened thereto.

The opposite sides 32a, 32b (see, e.g., FIG. 3) of the spacer member 30 includes fixing holes, for example, threaded holes, that are configured to accommodate fasteners 28, for example, screws. The spacer member may include at least two single bores extending across its two opposite sides. The two yoke plates are assembled to the spacer member with screw posts, also referred to as Chicago screws, as described, for example, in U.S. Pat. No. 10,931,188, which is expressly incorporated herein in its entirety by reference thereto.

As illustrated in FIG. 1, the fixation part 20b includes a plurality of legs 24 each having a fastening bore 25 for fasteners 28 that are fitted into the fixing holes arranged on respective opposite sides 32a, 32b of the spacer member 30 to set a constant gap between the first and second set of permanent magnets 16a, 16b.

The legs 24 are spaced apart from each other along the magnetic path to form periodic cut-out portions 27 to reduce the weight of the secondary part. The fixation part 20b of the reinforcement structure thus does not cover the entirety of spacer member's opposite sides 32a, 32b but only covers a fraction thereof. The fixation part may therefore cover less than 80% of the total surface of the spacer member's opposite sides and, for example, less than 60%, less than 50%, less than 40%, less than 30%, or even less.

As illustrated, the cut-out portions 27 between each pair of legs 24 have a substantially triangular shape. This specific shape results from the configuration of at least some legs that each include a fastening bore 25 for receiving the fastener 28. Each fastening bore 25 is aligned with a centered reinforcement beam 22 to follow the principal stress line of the fastener 28, thereby increasing and/or optimizing the rigidity of the yoke plates 12a, 12b. Two inclined beams 26a, 26b are arranged to form an integral part with two additional reinforcement beams 22 arranged on both sides of the centered reinforcement beam.

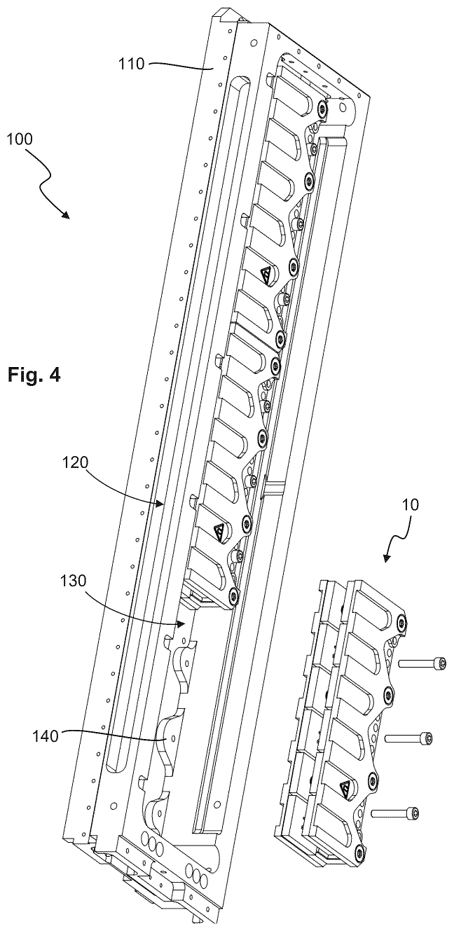

The spacer member's opposite sides 32a, 32b further include multiple assembly holes 34, as illustrated in FIG. 1, accessible between the plurality of legs 24 of the fixation part 20b of the reinforcement structure 20. These assembly holes 34, for example, threaded bores, are adapted to secure the secondary part 10 to a machine part or to a casing adapted to be fixed to a machine part, as described below with reference to FIG. 4. The spacer member 30 may include, for example, three, four, or more assembly holes between two legs 24 to allow a greater flexibility to comply with the customer machine part requirements. These plurality of assembly holes also, for example, decrease the weight of the spacer member 30.

For example, the fixing holes in spacer member 30 configured to accommodate fasteners 28 are identical to the assembly holes 34. In this manner, the spacer member 30 includes assembly holes 34 at a constant pitch on its entire length that can be used either as assembly holes or for fastening the fixation part 20b.

For example, the reinforcement part 20a of the reinforcement structure 20 includes periodic reinforcement beams 22 along the magnetic path 40. These reinforcement beams 22 extend parallelly from each other from a top side to a bottom side of the outer side 14 of respective yoke plates 12a, 12b. Each reinforcement beam 22 is aligned with the interface between two adjacent permanent magnets, as illustrated in FIG. 2, to keep the magnetic performance of the secondary part by guiding the magnetic field between two adjacent magnets of opposing polarity.

Referring to FIG. 4, the ironless linear motor may include a secondary part assembly 100 made of several secondary parts 10, as described above. An end of the spacer member and of the yoke plates of each secondary part 10 are disposed adjacently inside a rectangular recess 130 of a casing 110 in the longitudinal direction of the magnetic path. The casing 110 includes a longitudinal slot 120 aligned with the magnetic path of adjacent secondary parts 10 in which the glider can be inserted.

The casing 110 of the secondary part assembly 100 further includes fixation parts 140 against which the spacer member 30 of each secondary part 10 is fixedly mounted. The fixation of the spacer member 30 of each secondary part 10 directly on the fixation parts 140 of the casing ensures accurate placement of the permanent magnets in the casing, since the spacer member 30 has very precise dimensions. This ensures that the glider of the ironless linear motor is always well centered in the magnetic path 40 and never comes into contact with the permanent magnets 16a, 16b, even if the airgap is small to optimize motor performance, e.g., in the range of 0.1 to 1 mm.

The configuration of the fixation part 20a of the reinforcement structure 20 and the lightweight spacer member 30 reduce the overall weight of the secondary part 10, thereby improving the dynamic behavior of a motion system that includes XY motorized linear stages, such as semiconductor processing equipment.

It should be appreciated that the reinforcement beams are not necessarily straight and may extend along only a portion of the outer side of respective yoke plates. In addition, the width of each reinforcement beam may differ from each other, e.g., on both lateral sides of respective yoke plates.

### LIST OF REFERENCE NUMERALS

10 Secondary part
12a, 12b Yoke plates
13 Inner side
14 Outer side
16a, 16b Permanent magnets
20 Reinforcement structure
20a Reinforcement part
20b Fixation part
22 Reinforcement beams
24 Leg
25 Fastening bore
26a, 26b Inclined beams
27 Cut-out portions
28 Fastening means
30 Spacer member
32a, 32b Opposite sides
34 Assembly holes
40 Magnetic path
100 Secondary part assembly
110 Casing
120 Longitudinal slot
130 Rectangular recess
140 Fixation parts

What is claimed is:

1. A secondary part of an ironless linear motor, comprising:
a first yoke plate having an inner side and an outer side;
a second yoke plate having an inner side and an outer side;
a first set of permanent magnets fixed on the inner side of the first yoke plate;
a second set of permanent magnets fixed on the inner side of the second yoke plate;
a spacer member mounted between the first yoke plate and the second yoke plate; and
a first reinforcement structure having a reinforcement part arranged on the outer side of the first yoke plate and a fixation part affixed on a first side of the spacer member;
a second reinforcement structure having a reinforcement part arranged on the outer side of the second yoke plate and a fixation part affixed on a second side of the spacer member opposite the first side of the spacer member;
wherein the first set of permanent magnets and the second set of permanent magnets face each other to define a magnetic path for a primary part of the linear motor;
wherein the fixation part of the first reinforcement structure covers less than 80% of a surface area of the first side of the spacer member; and
wherein the fixation part of the second reinforcement structure covers less than 80% of a surface area of the second side of the spacer member.

2. The secondary part according to claim 1, wherein the first fixation part covers less than 60% of the surface area of the first side of the spacer member, and the second fixation part covers less than 60% of the surface area of the second side of the spacer member.

3. The secondary part according to claim 1, wherein the first fixation part covers less than 50% of the surface area of the first side of the spacer member, and the second fixation part covers less than 50% of the surface area of the second side of the spacer member.

4. The secondary part according to claim 1, wherein the first fixation part covers less than 40% or less than 30% of the surface area of the first side of the spacer member, and the second fixation part covers less than 40% or less than 30% of the surface area of the second side of the spacer member.

5. The secondary part according to claim 1, wherein the reinforcement part of the first reinforcement structure includes reinforcement beams spaced apart from each other and extending from a top side to a bottom side of the outer side of the first yoke plate, and the reinforcement part of the second reinforcement structure includes reinforcement beams spaced apart from each other and extending from a top side to a bottom side of the outer side of the second yoke plate.

6. The secondary part according to claim 5, wherein each reinforcement beam has a rectangular shape and is centered at an interface between two adjacent permanent magnets.

7. The secondary part according to claim 5, wherein the fixation part of the first reinforcement structure includes legs affixed to the first side of the spacer member and spaced apart from each other to form periodic cut-out portions therebetween, and the fixation part of the second reinforcement structure includes legs affixed to the second side of the spacer member and spaced apart from each other to form periodic cut-out portions therebetween.

8. The secondary part according to claim 7, wherein each leg includes a fastening bore aligned with a centered reinforcement beam and two inclined beams forming an integral part with two additional reinforcement beams arranged on both sides of the centered reinforcement beam.

9. The secondary part according to claim 7, wherein each cut-out portion has a substantially triangular shape.

10. The secondary part according to claim 7, wherein the spacer member includes a plurality of assembly holes between each pair of legs adapted to affix the secondary part to a machine part.

11. The secondary part according to claim 1, wherein the reinforcement part of the first reinforcement structure forms an integral part with the first yoke plate, and the reinforcement part of the second reinforcement structure forms an integral part with the second yoke plate.

12. The secondary part according to claim 1, wherein the first reinforcement structure has a uniform thickness, and the second reinforcement structure has a uniform thickness.

13. The secondary part according to claim 1, wherein the spacer member is formed of aluminum.

14. The secondary part according to claim 1, wherein the spacer member is formed of an aluminum alloy.

15. A secondary part assembly, comprising:
a plurality of secondary parts as recited in claim 1, the spacer member, the first yoke plate, and the second yoke plate of each secondary part being arranged adjacently in a longitudinal direction of the magnetic path with the respective spacer member, first yoke plate, and second yoke plate of an adjacent one of the secondary parts.

16. The secondary part assembly according to claim 15, further comprising a casing having a rectangular recess receiving the secondary parts, the recess including fixation parts, the spacer member of each secondary part being fixedly mounted to at least one fixation part of the recess.

17. The secondary part assembly according to claim 16, wherein the casing includes a longitudinal slot aligned with the magnetic path of each secondary part.

18. The secondary part assembly according to claim 17, wherein the longitudinal slot is adapted to receive a glider of the linear motor.

19. An ironless linear motor, comprising:
at least one secondary part recited in claim 1; and
a primary part movably mounted within the magnetic path.

20. The ironless linear motor according to claim 19, wherein the at least one secondary part includes a plurality of secondary parts, the spacer member, the first yoke plate, and the second yoke plate of each secondary part being arranged adjacently in a longitudinal direction of the magnetic path with the respective spacer member, first yoke plate, and second yoke plate of an adjacent one of the secondary parts.
